(19) United States
(12) Patent Application Publication
(10) Pub. No.: US 2026/0220547 A1
(43) Pub. Date: Jul. 30, 2026

(54) ENSEMBLE PRUNING MASKS FOR SEQUENTIAL UNLEARNING IN AN AI SYSTEM

(71) Applicant: Cisco Technology, Inc., San Jose, CA (US)

(72) Inventors: Gaowen Liu, Naperville, IL (US); Charles Fleming, Oxford, MS (US); Ramana Rao V.R. Kompella, Foster City, CA (US)

(73) Assignee: Cisco Technology, Inc., San Jose, CA (US)

(21) Appl. No.: 19/037,596

(22) Filed: Jan. 27, 2025

(51) Int. Cl. G06N 20/20

(52) U.S. Cl. CPC G06N 20/20

(57) ABSTRACT

In one implementation, a device performs model unlearning on a trained artificial intelligence model with respect to a first concept by applying a first pruning mask to the trained artificial intelligence model. The device generates a second pruning mask for the trained artificial intelligence model to unlearn a second concept. The device forms an ensemble pruning mask based on the first pruning mask and on the second pruning mask. The device performs model unlearning on the trained artificial intelligence model with respect to the second concept by applying the ensemble pruning mask to the trained artificial intelligence model.

### TECHNICAL FIELD

The present disclosure relates generally to ensemble pruning masks for sequential unlearning in an artificial intelligence (AI) system.

### BACKGROUND

Recent advancements in generative artificial intelligence (AI) models have opened new possibilities across various industries. Specifically, the ability of these models to follow instructions enables their integration with tools (e.g., plugins) that are able to perform tasks such as searching the web, executing code, etc. In addition, generative AI have also proven capable of generating content such as images, movies, and audio, to name a few.

The current trend in generative AI is towards versatile models that are capable of performing a wide variety of tasks. However, while versatile model can be beneficial in some instances, there are also cases in which some of the additional capabilities of the resulting model may be undesirable. For instance, a model trained to generate images or video may also be capable of generating sensitive, illegal, biased, copyrighted, or harmful/malicious content, among others. In further cases, it may also be that the capabilities of the trained model exceed the needs of a given deployment, meaning that deployment of the full model will consume additional resources needlessly.

For this reason, there has been recent interest in model unlearning whereby concepts and capabilities are removed from a previously trained model. However, applying model unlearning in a sequential manner can also inadvertently reactivate knowledge that was previously unlearned. For instance, performing unlearning on a model to unlearn how to generate a certain type of biased content may result in the model being able to generate a different type of biased content that was previously unlearned.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example of the sequential unlearning of concepts and capabilities from a trained AI model;

FIG. 6 illustrates an example of using pruning masks for model unlearning;

FIG. 7 illustrates an example of ensemble pruning masks for sequential unlearning;

FIG. 8 illustrates an example user interface for applying ensemble pruning masks for sequential unlearning; and

FIG. 9 illustrates an example simplified procedure for performing sequential unlearning using ensemble pruning masks, in accordance with one or more implementations described herein.

### DESCRIPTION OF EXAMPLE IMPLEMENTATIONS

### Overview

According to one or more implementations of the disclosure, a device performs model unlearning on a trained artificial intelligence model with respect to a first concept by applying a first pruning mask to the trained artificial intelligence model. The device generates a second pruning mask for the trained artificial intelligence model to unlearn a second concept. The device forms an ensemble pruning mask based on the first pruning mask and on the second pruning mask. The device performs model unlearning on the trained artificial intelligence model with respect to the second concept by applying the ensemble pruning mask to the trained artificial intelligence model.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

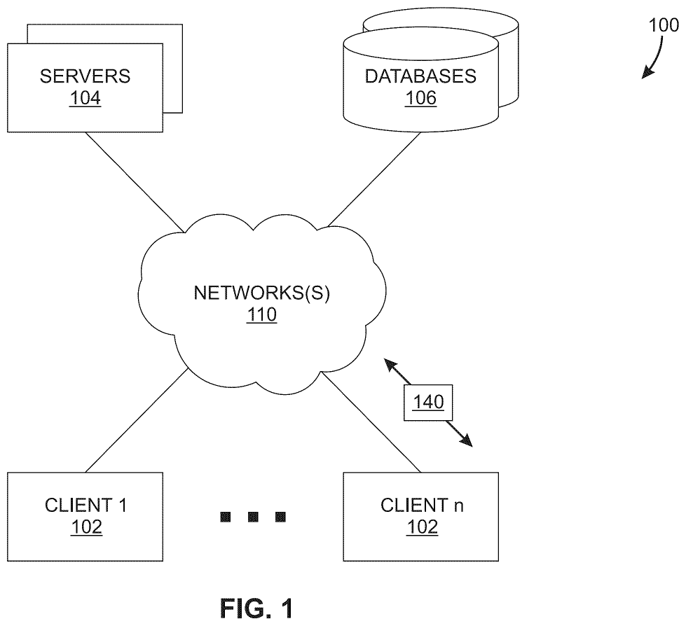

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

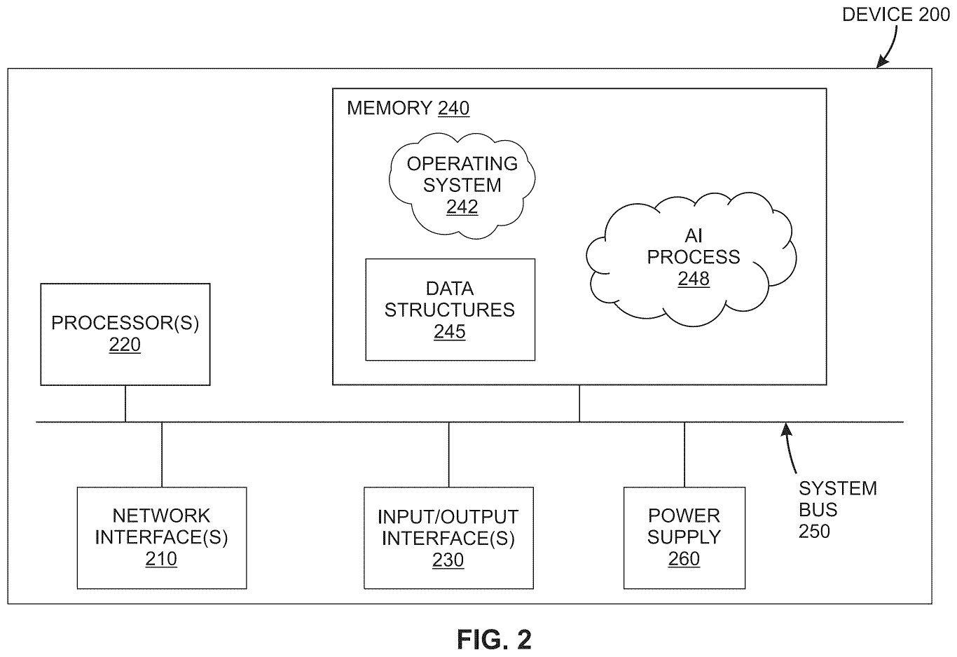

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that AI process 248 may use include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also make use of one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

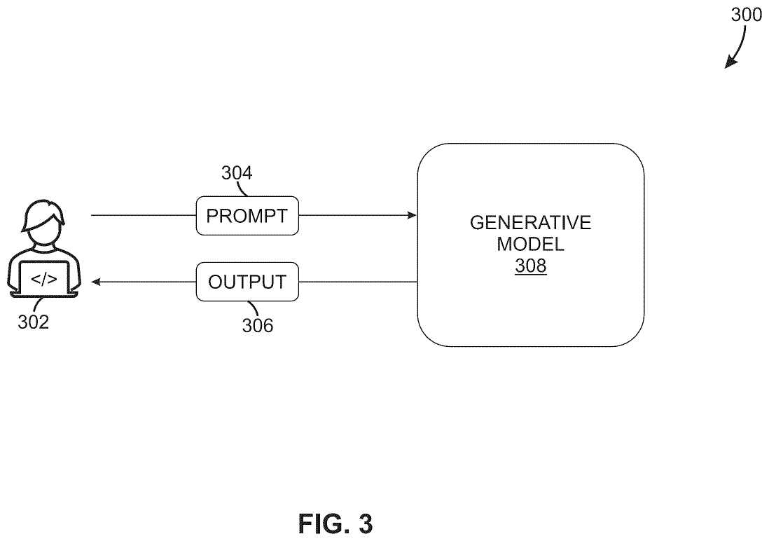

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

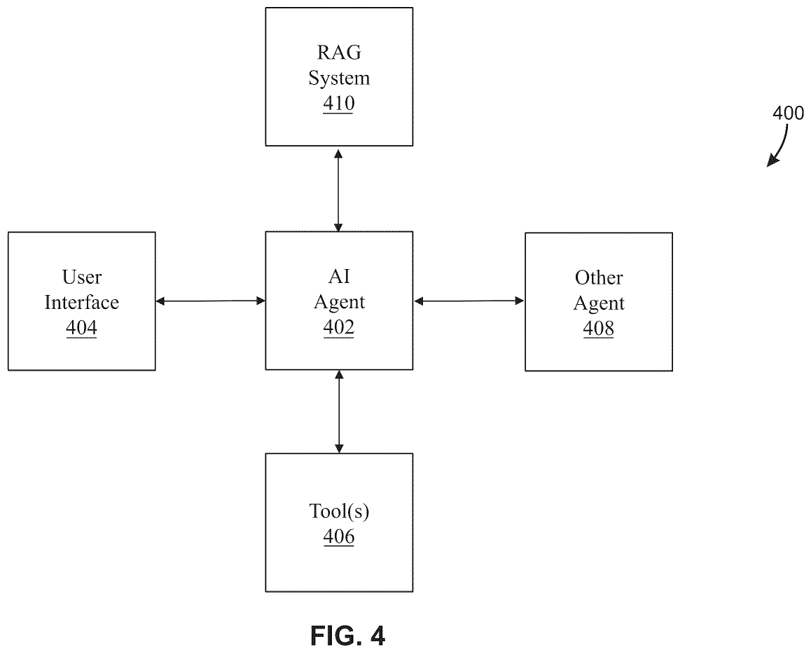

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, the current trend in generative artificial intelligence (genAI) is to train a model to perform a wide variety of tasks. For instance, consider the case of a genAI model that takes a textual description of an image as input and outputs a corresponding image. Such a model may be trained to generate images that depict thousands of different types of objects or actions, using different styles of depiction (e.g., Cubism, Van Gogh-style, etc.), and the like. This versatility allows the model to be used across different industries and use cases.

However, model versatility is also not without downsides. Indeed, the more versatile the model, the larger it is and the greater its resource requirements to execute. In addition, the larger the model, the longer it will take to process an input request. Further, model versatility can lead to the model being capable of generating content that is illegal, offensive, biased, or discriminatory.

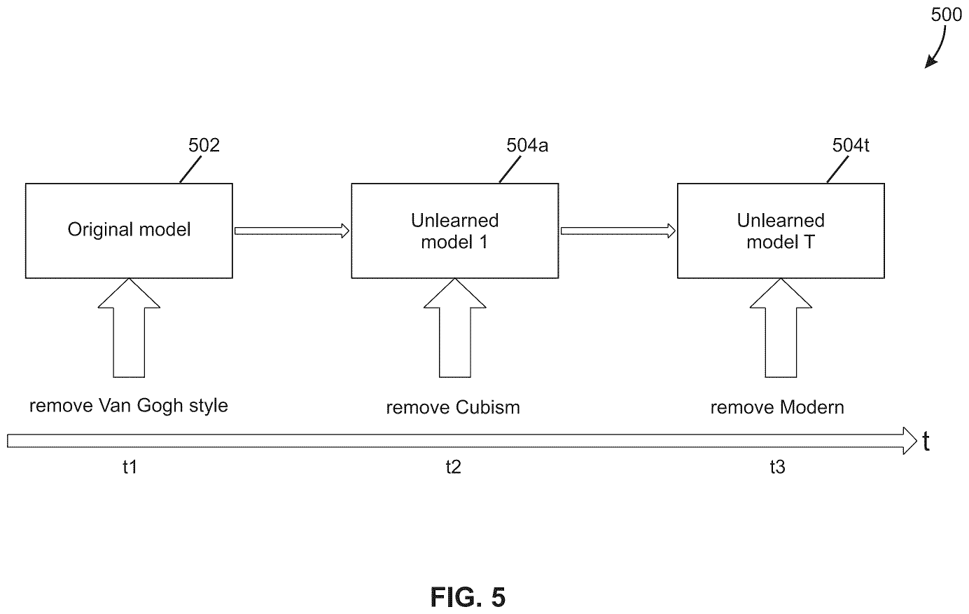

Accordingly, a recent focus in genAI has been on model unlearning, which entails removing capabilities and knowledge from a previously trained model. In some cases, model unlearning is performed sequentially over time, as shown in example 500 in FIG. 5.

More specifically, as shown in FIG. 5, assume that there is a model 502 that has been trained to generate images using a variety of different artistic styles including Van Gogh style, Cubism, Modern style, and the like. After model 502 has been trained, at time t1, at some point in time, t2, the system may perform model unlearning on it, to form unlearned model 504a. By way of example, such unlearning may remove the concept of Cubism from unlearned model 504a, thereby removing its ability to generate images in this style.

At a subsequent point in time, t3, then assume that the system performs additional unlearning on unlearned model 504a, to form unlearned model 504t. This unlearning may remove the concept of Modern painting style from the model, thereby removing the ability of unlearned model 504t from generating images in this style. However, there is a risk that performing unlearning of the concept of the Modern painting style will also inadvertently reactivate the model's understanding of the concept of Cubism.

### ——Ensemble Pruning Masks for Sequential Unlearning in an AI System——

The techniques herein allow for sequential model unlearning (e.g., removing concepts such as knowledge or capabilities from an AI model) without inadvertently reactivating previously removed concepts. More specifically, the techniques herein introduce an ensemble pruning mask that is based on previously used pruning masks for previously unlearned concepts and on a pruning mask for the current concept to be unlearned. In doing so, the ensemble pruning mask prevents previously unlearned neural connections, weights, and/or other parameters associated with those previously unlearned concept(s) from being reactivated during the current round of unlearning.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device performs model unlearning on a trained artificial intelligence model with respect to a first concept by applying a first pruning mask to the trained artificial intelligence model. The device generates a second pruning mask for the trained artificial intelligence model to unlearn a second concept. The device forms an ensemble pruning mask based on the first pruning mask and on the second pruning mask. The device performs model unlearning on the trained artificial intelligence model with respect to the second concept by applying the ensemble pruning mask to the trained artificial intelligence model.

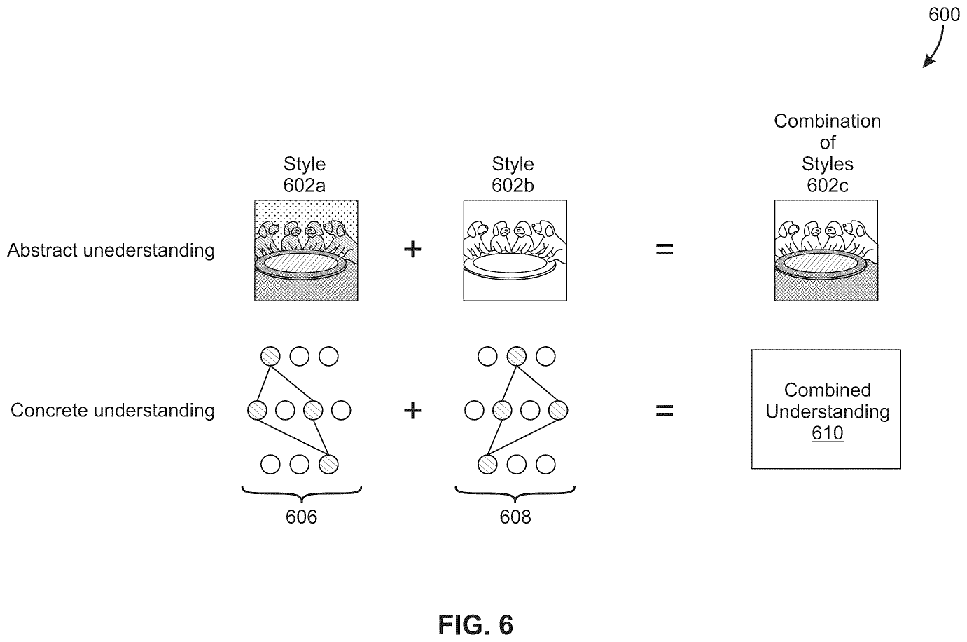

Operationally, FIG. 6 illustrates an example of using pruning masks for model unlearning, according to various implementations. As shown, assume that there is a generative AI model that has been trained to generate images using a variety of different styles such as style 602a (e.g., a cartoon style) and style 602b (e.g., a sketch style). From an abstract understanding perspective, the model may understand both of these concepts, allowing it to generate images based on user input. For example, a user may input a prompt of “generate an image of dogs playing poker in a cartoon style” or a prompt of “generate an image of a dog playing poker in a sketch style,” thereby causing the model to generate a corresponding image.

In some instances, the training of the AI model may also allow it to combine its abstract understanding of the concepts of style 602a and style 602b to produce images using a combination of styles 602c. For instance, the AI model may be able to generate a corresponding image given the prompt of “generate an image of dogs playing poker with the dogs in sketch style and the table in cartoon style.” Various training approaches are capable of producing a model that has such mixed capabilities such as the diffusion soup approach.

As would be appreciated, underlying the abstract understanding of the different stylistic concepts are the corresponding configurations within the AI model itself (e.g., its neuron connections, weights, and/or parameters). Thus, the abstract understanding of style 602a may correspond to a first configuration 606 within the AI model and abstract understanding of style 602b may correspond to a second configuration 608 within the AI model. The combination of these configurations corresponds to the combined understanding 610 that the model uses to generate content that combines both styles.

One potential approach to performing unlearning of a particular concept on an AI model entails the application of a pruning mask to the model. In general, a pruning mask functions by adjusting the configuration of the AI model such that certain portions of the model are removed from being able to affect the output of the model. This can be used in the context of model training by iteratively training the model, using the pruning mask to prune portions of the model, and training the model again to adapt to the loss of those portions. In addition, the pruning mask may be updated during each iteration, depending on the results of that training round. Doing so helps to make the model more robust to sparse data.

In the context of using a pruning mask for unlearning a particular concept, the general idea is to apply a pruning mask to the trained model such that that those portions of the model that are associated with the concept are effectively prevented from affecting the output of the model. For instance, one form of pruning mask is a binary mask that assigns values of either 0 or 1 within the model, to either disable or enable a given portion of the model, respectively. Various approaches such as back propagation can also be used to help optimize the mask to unlearn a particular concept.

However, in the case of sequential unlearning of different concepts over time, applying a pruning mask to unlearn a particular concept may inadvertently reenable/reactivate a portion of the model associated with a previously unlearned concept. To prevent this, the techniques herein propose that the unlearning system maintain a record of the pruning masks that it applies over time during unlearning and base its new masks on both the mask to be applied, as well as any previously applied masks, as well.

Thus, in the case of FIG. 6, the system may accomplish unlearning of style 602a by generating a pruning mask that removes the first configuration 606 and accomplish unlearning of style 602b by generating a pruning mask that removes the second configuration 608 from the model.

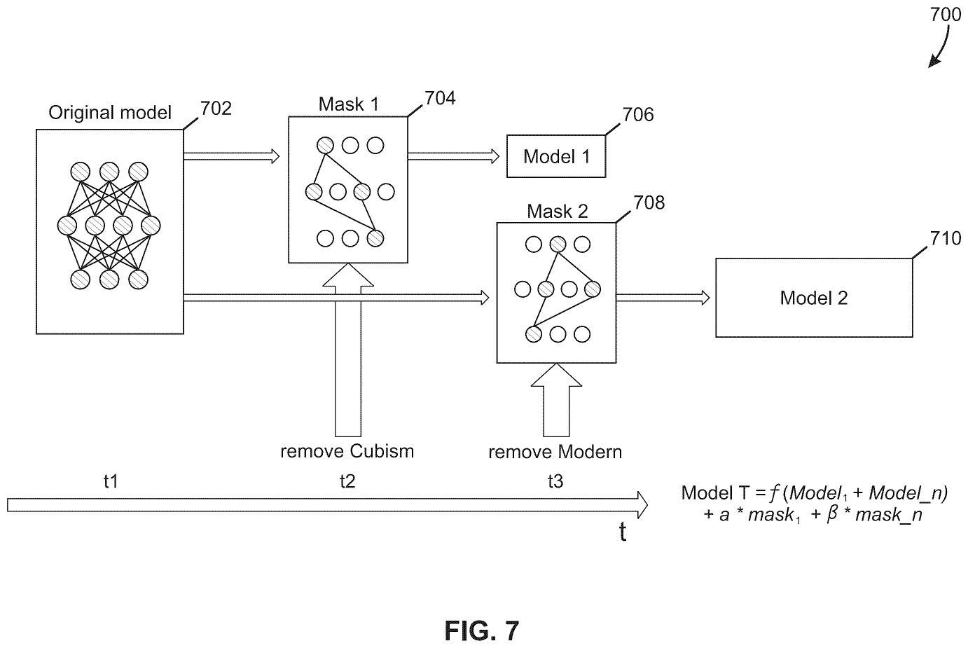

FIG. 7 illustrates an example 700 of ensemble pruning masks for sequential unlearning, according to various implementations. As shown, assume that there is a model 702 (e.g., an original model) at time t1 that has been trained to generate images using a variety of concepts/styles, such as Van Gogh style, Cubism style, and Modern style.

Next, at time t2, the system may receive a request to remove/unlearn the concept of Cubism from model 702. To do so, the system may generate a pruning mask 704. In turn, the system may apply pruning mask 704 to model 702, thereby resulting in model 706 (e.g., a first unlearned model).

At step time t3, the system may then receive a subsequent request to also unlearn the concept of Modern style from the model. In such a case, in one implementation, the system may apply a pruning mask 708 to model 702, thereby forming model 710 (e.g., a second unlearned model).

To ensure that the resulting model has unlearned both concepts, the system may generate an ensemble pruning mask that is based on pruning mask 704, pruning mask 708, and any other previously generated pruning mask. In some instances, the system may also apply weights to each of these masks, as follows:

$$α * {mask}_{1} + β * {mask}_{2} + …$$

In other words, the system may combine the pruning masks into an ensemble mask that, when applied to model 702, cause it to unlearn the set of concepts associated with those pruning masks. In some implementations, the system may apply the ensemble mask directly to model 702. However, as the system also applied the individual pruning masks to model 702 over time, the system may also apply the ensemble mask to a version of model 702 that is a function of the previously generated versions after each round of unlearning (e.g., a function of model 706, model 710, etc.). Regardless of which version of versions of model 702 is used, the end result of the proposed approach is a form of model 702 that has unlearned the cumulative set of concepts (e.g., Cubism, Modern style, etc.).

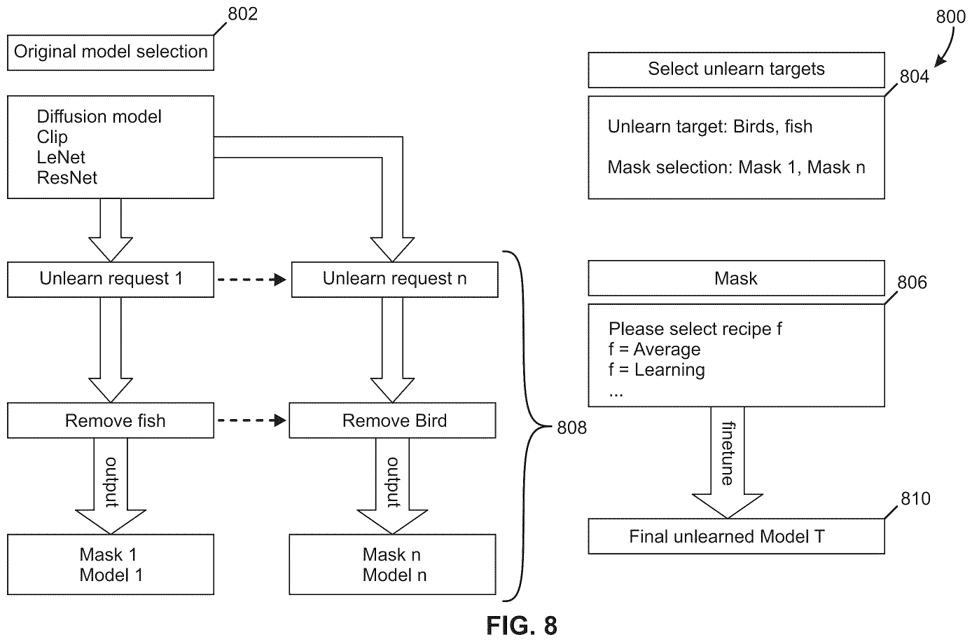

FIG. 8 illustrates an example user interface 800 for applying ensemble pruning masks for sequential unlearning. As shown, user interface 800 may include an input 802 that allows the user to select an original model that has been trained on a plurality of concepts. For instance, the user may select a type of model, such as a diffusion model, CLIP model, LeNet model, ResNet model, etc. that has been previously trained and is now eligible for unlearning.

Further, user interface 800 may also include input 804 that allows the user to select the target concepts to be unlearned. In doing so, the system may present the generated pruning masks (e.g., mask 1 . . . mask n) associated with those concepts. In a further instance, user interface 800 may also include an input 806 that allows the user to select a recipe f that the system may use when forming the ensemble mask from the selected masks. Such recipes may include average, learning, and the like.

In some implementations, user interface 800 may also present information 808 for review by the user regarding the unlearning requests over time and their corresponding masks. This allows the user to review the history of unlearning that the system performed and the changes that it made to the model over time.

Finally, user interface 800 may also present information 810 to the user regarding the final unlearned model that has unlearned the full set of concepts selected by the user.

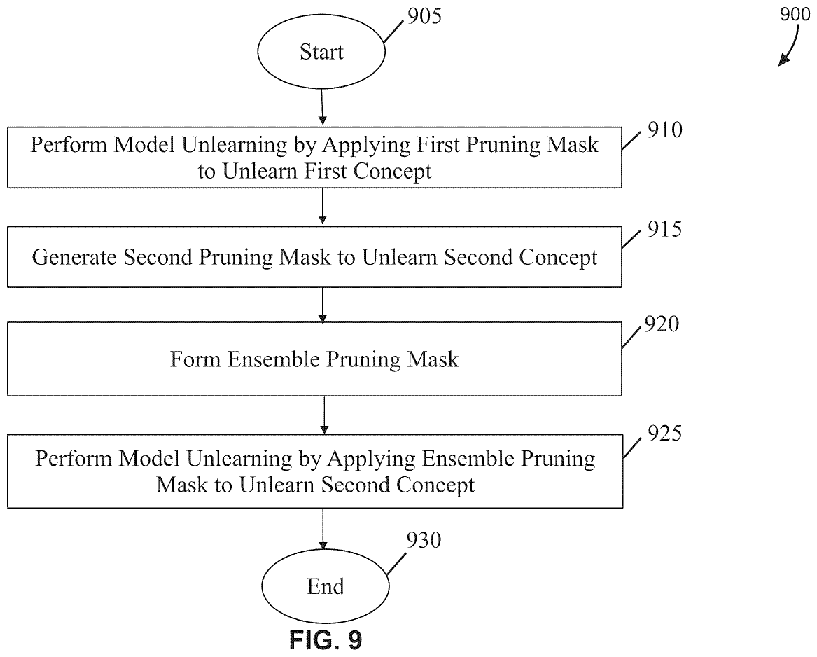

FIG. 9 illustrates an example simplified procedure for performing sequential unlearning using ensemble pruning masks, in accordance with one or more implementations described herein. For example, a non-generic, specifically configured device (e.g., device 200), may perform procedure 900 (e.g., a method) by executing stored instructions (e.g., AI process 248). The procedure 900 may start at step 905, and continues to step 910, where, as described in greater detail above, the device (e.g., a controller, server, etc.) may perform model unlearning on a trained artificial intelligence model with respect to a first concept by applying a first pruning mask to the trained artificial intelligence model. In various implementations, the trained artificial intelligence model is configured to generate text, an image, or both.

At step 915, as detailed above, the device may generate a second pruning mask for the trained artificial intelligence model to unlearn a second concept. In some instances, the device receives, via a user interface, a request to perform model unlearning on the trained artificial intelligence model with respect to the second concept.

At step 920, the device may form an ensemble pruning mask based on the first pruning mask and on the second pruning mask, as described in greater detail above. In some instances, the device may do so by applying weightings to the first pruning mask and the second pruning mask. In various implementations, the first pruning mask and the second pruning mask remove connections between neurons in the trained artificial intelligence model associated with the first concept and the second concept. In one implementation, the device forms the ensemble pruning mask in accordance with one or more parameters specified via a user interface. In various implementations, the ensemble pruning mask prevents the trained artificial intelligence model from reactivating knowledge of the first concept while unlearning the second concept.

At step 925, as detailed above, the device may perform model unlearning on the trained artificial intelligence model with respect to the second concept by applying the ensemble pruning mask to the trained artificial intelligence model. In various implementations, the first concept and the second concept correspond to different types of content that the trained artificial intelligence model is able to generate. The device may also provide an indication of the first pruning mask, the second pruning mask, and the ensemble pruning mask to a user interface. The device may also provide the trained artificial intelligence model for use by a user, after performing unlearning of the first concept and the second concept on the trained artificial intelligence model.

Procedure 900 may then end at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for concept-aware model unlearning via mixture of experts, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
performing, by a device, model unlearning on a trained artificial intelligence model with respect to a first concept by applying a first pruning mask to the trained artificial intelligence model;
generating, at the device, a second pruning mask for the trained artificial intelligence model to unlearn a second concept;
forming, by the device, an ensemble pruning mask based on the first pruning mask and on the second pruning mask; and
performing, by the device, model unlearning on the trained artificial intelligence model with respect to the second concept by applying the ensemble pruning mask to the trained artificial intelligence model.

2. The method as in claim 1, wherein the trained artificial intelligence model is configured to generate text, an image, or both.

3. The method as in claim 1, wherein the first concept and the second concept correspond to different types of content that the trained artificial intelligence model is able to generate.

4. The method as in claim 1, wherein forming the ensemble pruning mask comprises:
applying weightings to the first pruning mask and the second pruning mask.

5. The method as in claim 1, wherein the first pruning mask and the second pruning mask remove connections between neurons in the trained artificial intelligence model associated with the first concept and the second concept.

6. The method as in claim 1, further comprising:
receiving, at the device and via a user interface, a request to perform model unlearning on the trained artificial intelligence model with respect to the second concept.

7. The method as in claim 1, wherein the device forms the ensemble pruning mask in accordance with one or more parameters specified via a user interface.

8. The method as in claim 1, further comprising:
providing, by the device, an indication of the first pruning mask, the second pruning mask, and the ensemble pruning mask to a user interface.

9. The method as in claim 1, wherein the ensemble pruning mask prevents the trained artificial intelligence model from reactivating knowledge of the first concept while unlearning the second concept.

10. The method as in claim 1, further comprising:
providing, by the device, the trained artificial intelligence model for use by a user, after performing unlearning of the first concept and the second concept on the trained artificial intelligence model.

11. An apparatus, comprising:
one or more network interfaces;
a processor coupled to the one or more network interfaces and configured to execute one or more processes; and
a memory configured to store a process that is executable by the processor, the process when executed configured to:
perform model unlearning on a trained artificial intelligence model with respect to a first concept by applying a first pruning mask to the trained artificial intelligence model;
generate a second pruning mask for the trained artificial intelligence model to unlearn a second concept;
form an ensemble pruning mask based on the first pruning mask and on the second pruning mask; and
perform model unlearning on the trained artificial intelligence model with respect to the second concept by applying the ensemble pruning mask to the trained artificial intelligence model.

12. The apparatus as in claim 11, wherein the trained artificial intelligence model is configured to generate text, an image, or both.

13. The apparatus as in claim 11, wherein the first concept and the second concept correspond to different types of content that the trained artificial intelligence model is able to generate.

14. The apparatus as in claim 11, wherein the apparatus forms the ensemble pruning mask by:
applying weightings to the first pruning mask and the second pruning mask.

15. The apparatus as in claim 11, wherein the first pruning mask and the second pruning mask remove connections between neurons in the trained artificial intelligence model associated with the first concept and the second concept.

16. The apparatus as in claim 11, wherein the process when executed is further configured to:
receive, via a user interface, a request to perform model unlearning on the trained artificial intelligence model with respect to the second concept.

17. The apparatus as in claim 11, wherein the apparatus forms the ensemble pruning mask in accordance with one or more parameters specified via a user interface.

18. The apparatus as in claim 11, wherein the process when executed is further configured to:
provide an indication of the first pruning mask, the second pruning mask, and the ensemble pruning mask to a user interface.

19. The apparatus as in claim 11, wherein the ensemble pruning mask prevents the trained artificial intelligence model from reactivating knowledge of the first concept while unlearning the second concept.

20. A tangible, non-transitory, computer-readable medium storing program instructions that cause a device to execute a process comprising:
performing, by the device, model unlearning on a trained artificial intelligence model with respect to a first concept by applying a first pruning mask to the trained artificial intelligence model;
generating, at the device, a second pruning mask for the trained artificial intelligence model to unlearn a second concept;
forming, by the device, an ensemble pruning mask based on the first pruning mask and on the second pruning mask; and
performing, by the device, model unlearning on the trained artificial intelligence model with respect to the second concept by applying the ensemble pruning mask to the trained artificial intelligence model.
